(19) United States
(12) Patent Application Publication
(10) Pub. No.: US 2024/0388122 A1
(43) Pub. Date: Nov. 21, 2024

(54) ELECTRICAL POWER MANAGEMENT OF RECREATIONAL VEHICLES

(71) Applicant: Polaris Industries Inc., Medina, MN (US)

(72) Inventors: Donovan Fredrickson, Independence, MN (US); Matthew Contons, Brooklyn Park, MN (US); Zachary Sundberg, Wyoming, MN (US); Joshua Weed, Stacy, MN (US); Brian Brandt, Roseau, MN (US); Brian Krosschell, North Branch, MN (US); Daniel Rice, Stillwater, MN (US); Joseph L. DeFance, Roseville, MN (US)

(21) Appl. No.: 18/665,755

(22) Filed: May 16, 2024

Related U.S. Application Data
(60) Provisional application No. 63/467,465, filed on May 18, 2023.

(51) Int. Cl. H02J 9/00; B60R 16/033; G07C 5/08; H02J 7/00

(52) U.S. Cl. CPC H02J 9/002; B60R 16/033; G07C 5/0816; H02J 7/0063

(57) ABSTRACT

A method for dynamically controlling an electrical load of a recreational vehicle, including: defining predetermined load-shed levels, each load-shed level corresponding to a reduced electrical power output level supplied to electrically-powered devices; defining a device load-priority for each of the devices; receiving and processing battery data to determine a health of the battery; determining a total current draw on the battery when the recreational vehicle is operating; measuring an electrical output of a vehicle power-generation system; determining a load-shed level based on the determined health of the battery, current draw and electrical output of the power-generation system, the load-shed level corresponding to one of the predetermined load-shed levels; and selectively reducing electrical power supplied from the power-generation system or the battery to at least one of the electrically-powered devices based on the first load-shed level and the load-priority of the at least one electrical device.

### CROSS REFERENCE TO RELATED APPLICATIONS

This application claims the benefit of U.S. Provisional Patent Application No. 63/467,465, filed May 18, 2023, entitled ELECTRICAL POWER MANAGEMENT OF RECREATIONAL VEHICLES, the contents of which are expressly incorporated herein by reference.

### BACKGROUND

Generally, recreational vehicles, including side-by-side vehicles, all-terrain vehicles, off-road utility vehicles, motorcycles, snowmobiles and other such vehicles, have grown in size and complexity as their popularity and use increases. With this increase in size and complexity, more and more features and devices have been added to recreational vehicles, including factory-provided features and devices, as well as consumer-added features and devices. Many of these added devices require electrical power supplied from the recreational vehicle, such as accessory lighting, audio systems with speakers, accessory power ports, farm attachments, and so on. As a result, electrical power generation and charging systems of recreational vehicles may not be able to keep up with the increased electrical load, leading to early battery failure, stranded vehicle operators, and dissatisfied consumers. Although simply providing ever larger electrical power-generation and storage systems may be one solution, such a potential solution adds weight and cost to the recreational vehicle, and may never truly be able to keep pace with increasing vehicle power demands.

### SUMMARY

Embodiments of the present disclosure address the growing need to provide power to the ever-increasing number of powered devices and systems of recreational vehicles, without unnecessarily increasing electrical-power generation and storage capabilities.

Embodiments of the present disclosure accomplish this by measuring electrical vehicle loads, prioritizing the various electrical needs, and controlling electrical power consumed by the various systems and devices in a manner that maximizes system functionality without jeopardizing essential vehicle operations and battery health. Specific embodiments that include methods, systems and devices for efficient and effective electrical power management of recreational vehicle power generation and storage systems are described in greater detail below.

One embodiment of the invention includes a method for dynamically controlling an electrical load of a recreational vehicle that includes a load controller, a battery, a power-generating system and a plurality of electrically-powered devices. In this embodiment, the method includes: defining a device load-priority for each of the plurality of electrically-powered devices; receiving battery data at the load controller; processing the received battery data to determine a battery state; determining whether to reduce power consumed by one or more of the plurality of electrically-powered devices based on the battery state; and selectively reducing electrical power consumed by the at least one of the plurality of electrically-powered devices based on the battery state and the load-priority of the at least one of the plurality of electrical devices. The battery state may be a battery state-of-health and/or a battery state-of-charge.

This example method may also include determining whether to reduce power consumed by one or more of the plurality of electrically-powered devices based on the battery state and a parameter of the power-generating system. The method may also include determining whether and how much to reduce power consumption based on operation of the power-generating system, such as electrical output of the power-generating system, or based on engine speed.

In another example, the invention includes a method for dynamically controlling an electrical load of a recreational vehicle that includes a load controller, an engine, a battery, a power-generating system and a plurality of electrically-powered devices based on engine speed. In this embodiment, the method includes: defining a device load-priority for each of the plurality of electrically-powered devices; determining an engine rpm (revolutions per minute); determining whether the engine rpm is below a predetermined rpm threshold; and selectively reducing electrical power consumed by the at least one of the plurality of electrically-powered devices when the engine rpm falls below the predetermined rpm threshold.

One embodiment of the present disclosure is a method for dynamically controlling an electrical load of a recreational vehicle that includes a load controller, a power supply, such as a power-generation system and/or a battery, and a plurality of electrically-powered devices. In an embodiment, the method comprises: defining a plurality of predetermined load-shed levels, each load-shed level corresponding to a reduced electrical power output level consumed by the plurality of electrically-powered devices. In an embodiment, the method also comprises defining a device load-priority for each of the plurality of electrically-powered devices; receiving battery data at the load controller when the recreational vehicle is operating in a first operating mode; processing the received battery data to determine a state-of-health of the battery; measuring an electrical parameter of the power-generation system when the recreational vehicle; determining a first load-shed level based on the determined state-of-health of the battery, and/or the electrical parameter of the power-generation system, the first load-shed level corresponding to one of the plurality of predetermined load-shed levels; and selectively reducing electrical power supplied from the power-generation system or the battery to at least one of the plurality of electrically-powered devices based on the first load-shed level and the load-priority of the at least one of the plurality of electrical devices.

Another embodiment of the present disclosure is a method for dynamically controlling an electrical load of a recreational vehicle that includes a plurality of electrically-powered devices, comprising: measuring an electrical parameter of a battery of the recreational vehicle; determining that the electrical parameter of the battery deviates from a predetermined electrical-parameter threshold; reducing electrical power consumed by a first electrically-powered device or the plurality of electrically-powered devices from a first initial electrical power consumed to a first reduced electrical power consumed, based on the deviation of the electrical parameter of the battery; reducing electrical power consumed by a second electrically-powered device or the plurality of electrically-powered devices from a second initial electrical power consumed by to a second reduced electrical power supplied, wherein a ratio of the second reduced electrical power supplied to the second initial reduced electrical power supplied is less than a ratio of the first reduced electrical power supplied to the first initial electrical power supplied, such that a percentage reduction of electrical power supplied to the second electrically-powered device is greater than a percentage reduction of electrical power consumed by the first electrically-powered device, based on the deviation of the electrical parameter of the battery from the predetermined electrical-parameter threshold.

Another embodiment of the present disclosure is a method for dynamically controlling an electrical load of a recreational vehicle that includes a plurality of electrically-powered devices, comprising: defining a device load-priority for each of the plurality of electrically-powered devices; defining a plurality of predetermined load-shed levels, each load-shed level corresponding to a reduced electrical power output level supplied to the plurality of electrically-powered devices or to a load controller reducing functionality; determining a battery status, the battery status including one or more of a battery state-of-health, battery state-of-charge, battery voltage, or battery current draw; measuring a parameter of an environment of the vehicle using a battery sensor in communication with a load controller of the vehicle; receiving data at the load controller, the data corresponding to the measured parameter of the battery of the vehicle; selecting one of the plurality of load-shed levels based on the battery status; and transmitting command data from the load controller causing a reduction in electrical power supplied to at least one of the electrically-powered devices or reduced functionality of the electrically-powered device based on the selected load-shed level and the measured parameter of the environment of the vehicle.

Yet another embodiment of the present disclosure is a system for dynamically controlling an electrical load of a recreational vehicle, comprising: a plurality of electrically-powered devices; an electrical power generation and storage system in electrical connection with the plurality of electrically-powered devices; a primary recreational-vehicle controller configured to control and communicate with a plurality of recreational vehicle systems; a vehicle load controller in electrical communication with one or more of the plurality of electrically-powered devices, the vehicle load controller configured to selectively cause the one or more of the plurality of electrically-powered devices to reduce power consumed based on a measured or predicted recreational-vehicle parameter. Recreational-vehicle parameters may include various recreational-vehicle battery parameters, such as battery voltage, battery state-of-health, battery state-of-charge and so on. Other parameters may include engine speed, power generation, and other such parameters.

Another embodiment of the present disclosure is a system for dynamically controlling an electrical load of a recreational vehicle, comprising: a plurality of electrically-powered devices, each of the plurality of electrically-powered devices associated with a device load-shed priority level; an electrical power generation and storage system in electrical connection with the plurality of electrically-powered devices; a primary recreational-vehicle controller configured to control and communicate with a plurality of recreational vehicle systems; a vehicle load controller including a vehicle load controller processor and vehicle load controller memory, the vehicle load controller in electrical communication with the primary recreational-vehicle controller, electrical power generation and storage system and the plurality of electrically-powered devices, the vehicle load controller configured to: receive data regarding a status of the electrical power generation and storage system; process the received data regarding the status of the electrical power generation and storage system to determine a load-shed level for the recreational vehicle; and transmit command data requesting a reduction in electrical power consumed by at least one of the plurality of electrically-powered devices based on the determined load-shed level and the device load-shed priority level of the at least one of the plurality of electrically-powered devices.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The disclosure can be understood in consideration of the following detailed description of various embodiments in connection with the accompanying drawings, in which:

FIG. 1 is a perspective view of a recreational vehicle, according to an embodiment of the present disclosure;

FIG. 2 is a right-side view of the recreational vehicle of FIG. 1, according to an embodiment of the present disclosure;

FIG. 3 is a top view of the recreational vehicle of FIG. 1, according to an embodiment of the present disclosure;

FIG. 4 is a front view of the recreational vehicle of FIG. 1, according to an embodiment of the present disclosure;

FIG. 5 is a rear view of the recreational vehicle of FIG. 1, according to an embodiment of the present disclosure;

FIG. 6 is a right-side view of the recreational vehicle of FIG. 1 with body panels, wheels and other components removed, according to an embodiment of the present disclosure;

FIG. 7 is a block diagram of a recreational vehicle, according to an embodiment of the present disclosure;

FIG. 8 is a block diagram of a recreational vehicle dynamic load-control system, according to an embodiment of the present disclosure;

FIG. 9 is a graph of recreational vehicle electrical power output vs. vehicle engine speed, according to an embodiment of the present disclosure;

FIG. 10 is a graph of electrical current draw for a plurality of electrically-powered devices or loads of a recreational vehicle, according to an embodiment of the present disclosure;

FIG. 11 is a flowchart depicting and describing a method for dynamically controlling an electrical load of a recreational vehicle, according to an embodiment of the present disclosure; and

FIG. 12 is a flowchart depicting and describing a method of determining a load-shed level based on a vehicle electrical load state, according to an embodiment of the present disclosure.

### DETAILED DESCRIPTION

For the purposes of understanding the disclosure, reference will now be made to the embodiments illustrated in the drawings, which are described below. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all combinations, modifications, equivalents, and alternatives falling within the spirit and scope of the invention as defined by the appended claims.

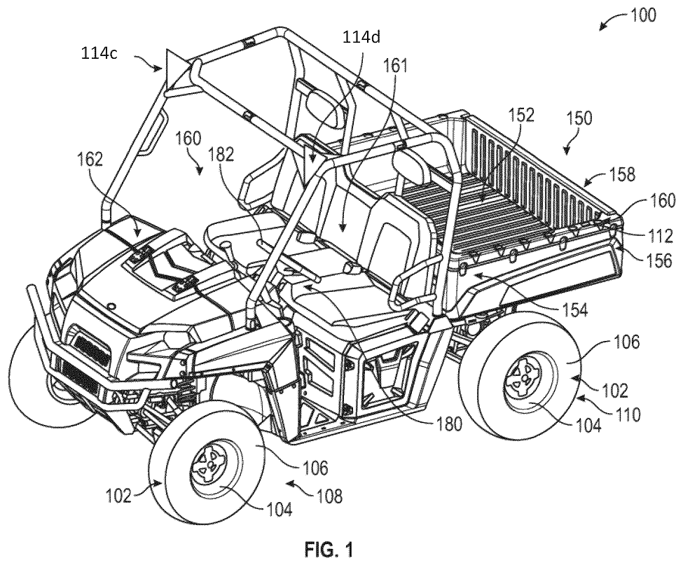

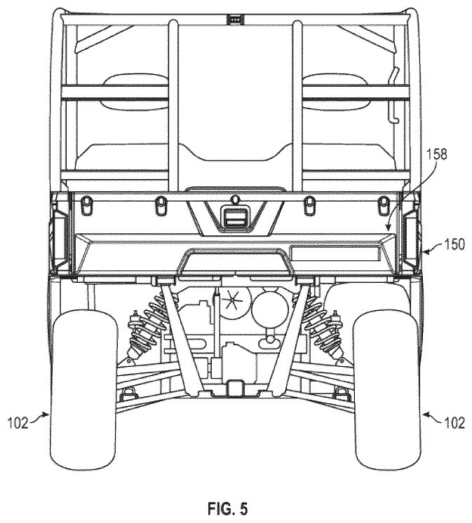

Referring to FIGS. 1-6, an illustrative embodiment of a recreational vehicle 100 is shown. Although recreational vehicle 100 is depicted as a side-by-side off-road vehicle (ORV), it will be understood that vehicle 100 may comprise any of a variety of recreational vehicles, and includes vehicles such as all-terrain vehicles (ATVs), side-by-side or utility terrain vehicles (UTVs), off-highway motorcycles (OHMs), other motorcycles, snowmobiles, and similar such vehicles. Hereinafter, such vehicles are collectively referred to as “recreational vehicles 100” or simply “vehicles 100.”

Vehicle 100 as illustrated includes a plurality of ground-engaging members 102. Illustratively, ground engaging members 102 are wheels 104 and associated tires 106. Other examples of ground-engaging members include skis and tracks.

As described herein, one or more of ground-engaging members 102 are operatively coupled to a prime mover 110 to power the movement of vehicle 100. Example power movers include internal combustion engines and electric engines.

Referring to the illustrated embodiment in FIG. 1, a first set of wheels, one on each side of vehicle 100, generally correspond to a front axle 108. A second set of wheels, one on each side of vehicle 100, generally correspond to a rear axle 109. Although each of front axle 108 and rear axle 109 are shown having a single ground engaging members 102 on each side, multiple ground engaging members 102 may be included on each side of the respective front axle 108 and rear axle 109.

As configured in FIG. 1, vehicle 100 is a four-wheel, two-axle vehicle. In one embodiment, one or more modular subsections (not pictured) may be added to vehicle 100 to transform vehicle 100 into a three axle vehicle, a four axle vehicle, and so on.

Vehicle 100 includes an operator area 160 generally supported by operator area portion 126 of frame 116. Operator area 160 includes seating 161 for one or more passengers. Operator area 160 further includes a plurality of operator controls 180 by which an operator may provide input into the control of vehicle 100. Controls 180 include a steering wheel 182, which is rotated by the operator to change the orientation of one or more of ground engaging members 102, such as the wheels associated with front axle 108, to steer vehicle 100. In one embodiment, steering wheel 182 changes the orientation of the wheels of front axle 108 and rear axle 109 to provide four-wheel steering. In embodiments, controls 180 also include a first foot pedal actuatable by the vehicle operator to control the acceleration and speed of vehicle 100 through the control of prime mover 110 and a second foot pedal actuatable by the operator to decelerate vehicle 100 through a braking system.

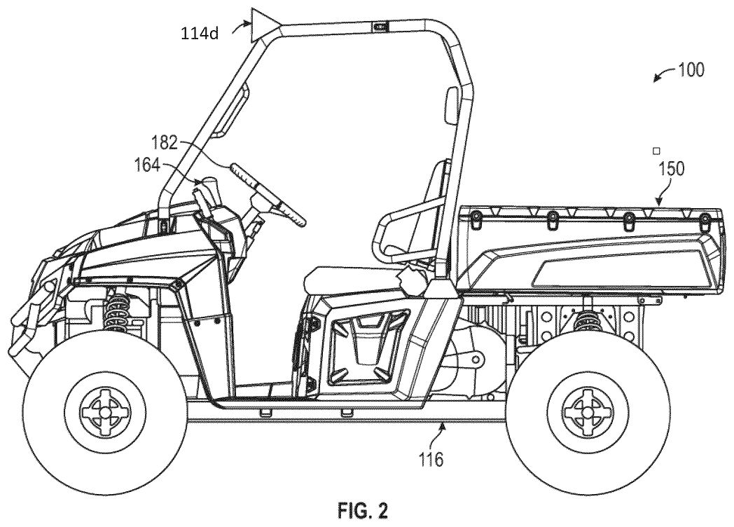

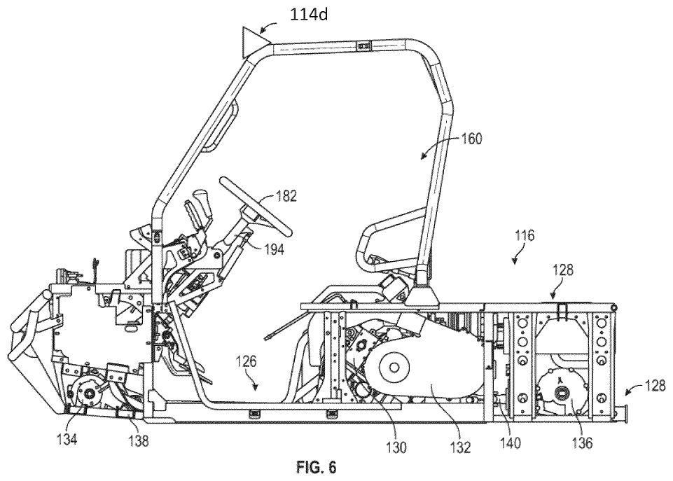

As depicted in FIGS. 2-4, controls 180 may also include gear shift input control 164, which is operatively coupled to the shiftable transmission of transmission 132 (FIG. 6) to communicate whether the shiftable transmission is in a low forward gear, a high forward gear, a reverse gear, neutral, and if included a park position. Although, gear shift input control 164 is shown as a lever, other types of inputs may be used. Gear-shift input control 164 is positioned on a right hand side of steering column 194.

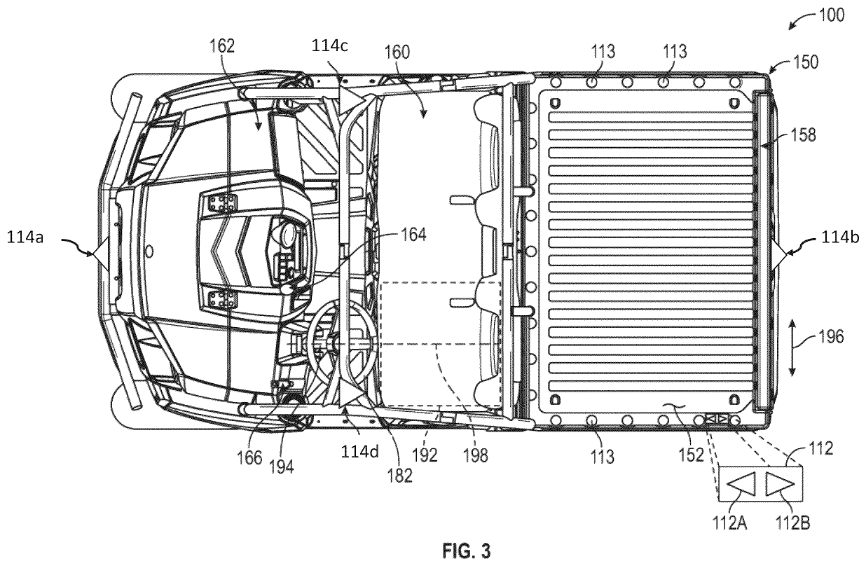

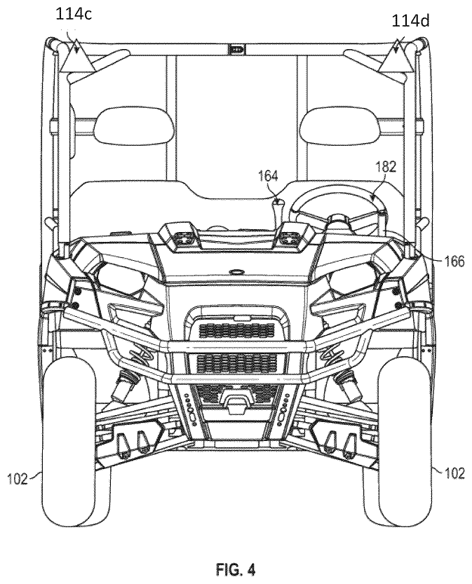

Controls 180 may also include a parking-brake input control 166, as shown in FIGS. 3-4. Parking brake input control 166 is operatively coupled to a parking brake of vehicle 100. In one embodiment, the parking brake is positioned on one of drive line 138 and drive line 140. In one embodiment, a master cylinder that is operatively coupled to parking brake input control 166 is positioned underneath a dashboard body member 162. Although, parking brake input control 166 is shown as a lever, other types of inputs may be used. Parking brake input control 166 is positioned on a left-hand side of steering column 194.

A vehicle operator position 192 on seating 161 is represented in FIG. 3. A steering column 194 is connected to steering wheel 182 (FIGS. 3 and 6).

Vehicle 100 is further illustrated as comprising object sensors 114, including front and rear sensors 114a and 114b (see FIG. 3) and left and right sensors 114c and 114d. Example sensors include, but are not limited to cameras (e.g., visible light cameras or infrared cameras), LIDAR, radar or ultrasonic sensors, global positioning system (GPS) sensors, magnetometers (e.g., to measure a relative and/or global magnetic field), and/or radio devices. For example, object sensors 114 may each comprise an ultra-wideband (UWB) radio, such that the position of another device (e.g., an operator device or a removable input device) may be determined. As another example, object sensors 114 may include one or more infrared and/or visible light cameras, such that computer-vision techniques may be used to perform object recognition to identify one or more objects surrounding vehicle 100 or, as a further example, a heat signature may be used to identify an operator of vehicle 100.

Referring to FIG. 6, a prime mover 110, illustratively an internal combustion engine, is supported by frame 116. Prime mover 110 is shown as a combustion engine. In one embodiment, prime mover 110 is a multifuel engine capable of utilizing various fuels. An example multifuel engine capable of utilizing various fuels is disclosed in U.S. Pat. No. 7,431,024, issued Oct. 7, 2008 and entitled “Method and Operation of an Engine”, the disclosure of which is expressly incorporated by reference herein. In one embodiment, prime mover 110 is a hybrid electric engine. In one embodiment, prime mover 110 is an electric motor.

Prime mover 110 is coupled to a front differential 134 and a rear differential 136 through a transmission 132 and respective drive line 138 and drive line 140. Drive line 138 and drive line 140, like other drive lines mentioned herein, may include multiple components and are not limited to straight shafts. For example, front differential 134 may include two output shafts (not pictured), each coupling a respective ground engaging members 102 of front axle 108 to front differential 134. In a similar fashion, rear differential 136 includes two output shafts, each coupling a respective ground engaging members 102 of rear axle 109 to rear differential 136.

In one embodiment, transmission 132 may include a shiftable transmission and a continuously variable transmission (“CVT”). The CVT is coupled to prime mover 110 and the shiftable transmission. The shiftable transmission is coupled to drive line 138, which is coupled to front differential 134 and to drive line 140 which is coupled to rear differential 136. In one embodiment, the shiftable transmission is shiftable between a high gear for normal forward driving, a low gear for towing, and a reverse gear for driving in reverse. In one embodiment, the shiftable transmission further includes a park setting, which locks the output drive of the shiftable transmission from rotating. In other examples, one or more axles (e.g., axle 108 or 109) may be non-powered axles.

Various configurations of front differential 134 and rear differential 136 are contemplated. Regarding front differential 134, in one embodiment front differential 134 has a first configuration wherein power is provided to both of the ground engaging members 102 of front axle 108 and a second configuration wherein power is provided to one of ground engaging members 102 of front axle 108.

Additional discussion of an embodiment of a recreational vehicle 100 and related aspects are disclosed in U.S. Pat. No. 7,950,486, the disclosure of which is expressly incorporated by reference herein. Embodiments of vehicle 100 that include snowmobiles are described in U.S. Pat. No. 8,590,654, issued Nov. 26, 2013 and entitled “Snowmobile,” in U.S. Pat. No. 8,733,773, issued May 27, 2014 and entitled “Snowmobile Having Improved Clearance for Deep Snow,” in U.S. Patent Pub. No. 2014/0332293A1, published Jul. 23, 2014 and entitled “Snowmobile,” and in U.S. Pat. No. 11,110,994, issued Sep. 7, 2021 and entitled “Snowmobile,” all of which are assigned to Polaris Industries Inc., and all of which are incorporated herein by reference in their entireties.

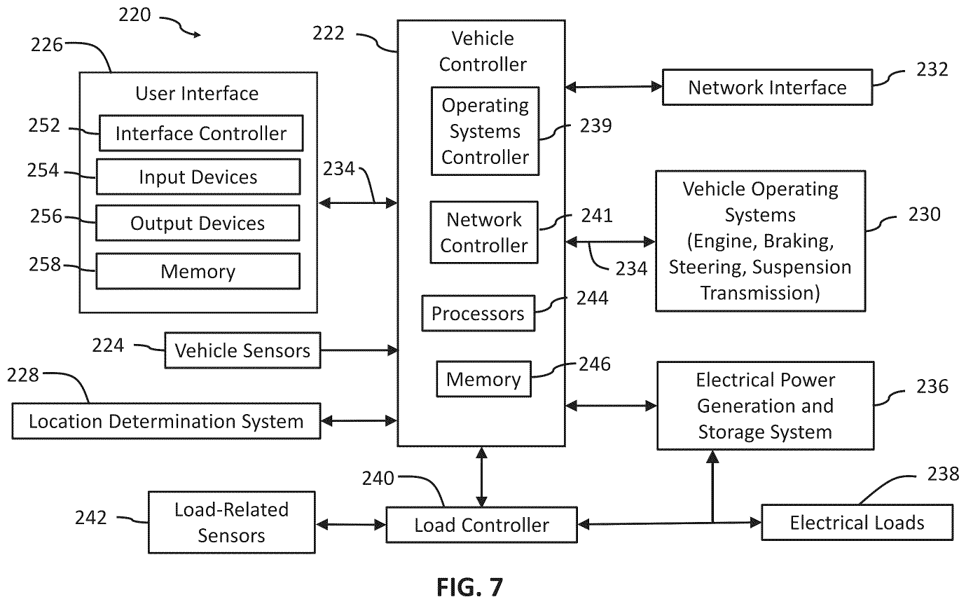

Referring also to FIG. 7, a system diagram of recreational vehicle 100 is depicted. Recreational-vehicle system 220 as depicted includes portions of electrical, control, and communication systems of vehicle 100, which in an embodiment includes vehicle controller 222, vehicle sensors 224, user interface 226, location determination system 228, vehicle operating systems 230, network interface 232, electrical power generation and storage system 234, and vehicle controller area networks (CAN) bus 234.

Vehicle controller 222, in an embodiment, comprises a vehicle electronic control module with one or more electronic control units (ECUs) having processors and memory for controlling electrical systems or subsystems of vehicle 100. Vehicle controller 222 may comprise a single control device or distributed control devices. Functions of vehicle controller 222 may be performed by hardware and/or computer instructions saved on non-transient, computer-readable storage mediums, such as memory 246. Controllers within, or connected to, vehicle controller 222 may use memory 246 to store and/or retrieve information. Vehicle controller 222 controls most processes related to operation of recreational vehicle 100.

In the embodiment depicted, vehicle controller 222 includes operating systems controller 239, network controller 241, one or more processors 244 and memory 246. Additional controllers or ECUs not depicted may also be present, such as those specific to control operating systems 230 or other connected devices. Operating systems controller 239, which may include multiple ECUs, is configured to control the various operating systems 230, including engine/prime mover 110, transmission system 112, braking system 114 and steering system 116. Network controller 241, in an embodiment, facilitates communication of devices connected to vehicle controller 222 over controller area network 234.

Memory 246, in an embodiment, includes computer-readable media in the form of volatile and/or nonvolatile memory and may be removable and/or non-removable. Embodiments include random access memory (RAM), read only memory (ROM), electronically erasable programmable read only memory (EE-PROM), flash memory, optical or magnetic storage devices, and/or other medium that can be used to store information and can be accessed by electronic devices. Memory 246 is configured to store various types of vehicle data and executable computer-program instructions.

User interface 226 is in electrical communication with vehicle controller 222, and may comprise any of a variety of human-machine interface devices configured to receive input from a user and transmit the received input to vehicle controller 222, as well as to receive an output from vehicle controller 222 and communicate or present that output to a vehicle operator or user. In an embodiment, user interface 226 includes interface controller 252, input devices 254, output devices 256 and memory 258.

Interface controller 252 may be configured to control operations of user interface 226 and its subsystems, as well as input devices 254 and output devices 256. Interface controller 226 may include or form a portion of a processing system that includes one or more computing devices that may include memory, processing capability, and communication hardware. Interface controller 252 may be a single device or a distributed device, and functions may be performed by hardware and/or as computer instructions on a non-transient computer-readable storage medium, such as memory 258, which shares the properties described above with respect to memory 246. As described further below, interface controller 252 may interpret input from input devices 254, particularly “touches” from a user touching an input device 224 that includes a touch-screen display.

Input devices 254 may include touch-screen displays, frequency-operated buttons (FOBs), buttons, switches, selectors and so on.

Output devices 256 may include displays, touch screens (that may function as both output and input devices), lights, audio devices, tactile devices and other such suitable output devices. In an embodiment, an input device 254 may also function as an output device.

Location-determination system 228, in an embodiment, is configured to determine a current location of vehicle 100, and to save and recall prior vehicle location data. Location-determination system 228 is in communication with vehicle controller 222 through CAN bus 234, or alternately, through a wireless network. In an embodiment, location-determination system 228 includes comprises a global positioning system (GPS). In another embodiment, location-determination system 228 may comprise a vehicle telematics system.

Vehicle operating systems 230 includes the various operations systems of utility vehicle 100, such as prime mover 110 with its associated components and systems, transmission system 112, braking system 114, steering system 116, and other vehicle systems associated with vehicle operations. Vehicle controller 222 receives input from an operator and controls the operation of the vehicle system, including movement, braking and steering of vehicle 100.

Network interface 232, in an embodiment, is connected to, or in communications with, vehicle controller 222, and is configured to connect vehicle 100 to an external computer network, such as the internet, or a local area network. In an embodiment, network interface 232 may comprise a network controller, transmitter, receiver, and various hardware and software computer instructions saved in a memory device.

CAN bus 234 comprises a vehicle bus system that connects the various devices of system 220, facilitating communications between the devices, including between vehicle controller 222 and connected devices as depicted. In an embodiment, CAN bus 234 may comprise a single vehicle controller area network, or may comprise portions of multiple, system-specific CAN buses 234, such as a vehicle CAN bus, peripheral CAN bus, telematics CAN bus, and so on.

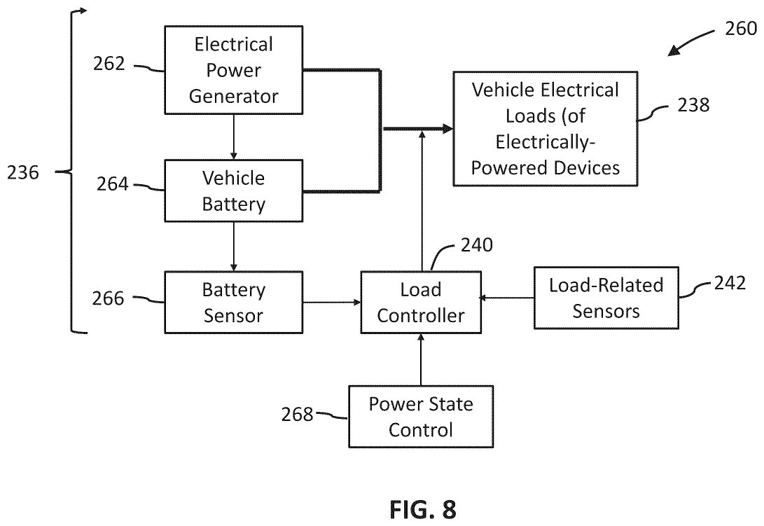

Referring also to FIG. 8, electrical power generation and storage system 236, in an embodiment, includes electrical power generator 262, vehicle battery 254, and battery sensor 266. Electrical power generator 262 provides electrical power to the various electrical devices and loads of vehicle 100. Electrical power generator 262 provides electrical power to vehicle battery 254, electrically charging vehicle battery 254 as needed.

Electrical power generator 262 may comprise any of a variety of electrical power generating devices or systems that converts mechanical energy from vehicle 100, such as from prime mover 110, to electrical energy. In an embodiment, electrical power generator 262 comprises an alternator or alternating current generator (ACG), which in an embodiment, is powered by a drive mechanism, such as a belt, of vehicle 100. The alternator may include, or be connected to, electrical components to convert generated alternating-current (AC) power to direct current (DC) power, and a regulator. In another embodiment, electrical power generator 262 comprises a generator that includes a stator and rotor arrangement, as is commonly used in some recreational vehicles.

Vehicle battery 254 may comprise any of a variety of known vehicle batteries of various sizes, capacities, and compositions, including lithium-ion, lead-acid, gel, and other types of batteries. Vehicle battery 254 is in electrical connection with electrical power generator 262, as well as electrical devices and loads 238 of vehicle 100.

Battery sensor 266 is in electrical communication with vehicle battery 254, and is configured to measure or detect a battery status, including detecting various parameters of vehicle battery 254, such as battery current draw, battery temperature, battery capacitance, and other parameters. In an embodiment, battery sensor 266 comprises a single element, but in other embodiments, the functionality of battery sensor 266 may be distributed to multiple battery-sensor devices.

Electrical loads 238 comprise various electrically-powered devices of vehicle 100 that require electrical power to operate. When these electrically-powered devices receive power from electrical power generation and storage system 236, they represent a “load” on system 236, so may be referred to collectively as an “electrical load” or “electrical loads.” While all electrically-powered devices receiving power from electrical power generation and storage system 236 are electrical loads, not all such devices are in communication with, and controlled by, load controller 240, as will be described further below. Rather, embodiments of the present invention selectively control only some of the various electrically-powered devices of vehicle 100.

Load controller 240 is in electrical communication with vehicle controller 222, electrical power generation and storage system 236, electrical loads 238 and load-related sensors 242. In an embodiment, load controller 240 is not in direct communication with electrical loads 238, but is in communication with electrical loads 238 through other control devices. In one such embodiment, load controller 240 communicates control instructions to a electronic control unit (ECU) that controls the particular electrically-powered device that is an electrical load 238.

In an embodiment, load controller 240 comprises one or more computing devices, including hardware such as processors and memory devices, as well as computer software and instructions stored in the memory devices. Load controller 240 be a stand-alone, separately functioning controller or control device, such as an ECU, or may be integrated into vehicle controller 222 and/or other ECUs of vehicle system 220.

In an embodiment, system 260 may include multiple load controllers 240, each load controller 240 corresponding to one or electrical loads.

Load-related sensors 242 are in electrical communication with load controller 240, transmitting measured or sensed data to the controller. In an embodiment, load-related or environmental sensors 242 measure or sense conditions that may affect power consumption of an electrical load 238, such as ambient temperature, device temperature, device current draw, and so on. In another embodiment, one or more load-related sensors 242 sense conditions that may allow power to an electrical load 238 to be reduced, such as an ambient light sensor that suggests reducing power to a vehicle light may be appropriate. The use of load-related sensors 242 is described further below.

Referring specifically to FIG. 8, an embodiment of recreational vehicle dynamic load-control system 260 is depicted. In this embodiment, dynamic load-control system 260 includes electrical power generation and storage system 236 powering vehicle electrical loads 238, load controller 240, load-related sensors 242 and power-state control device 268. In an embodiment, and as depicted, electrical power generation and storage system 236 includes electrical power generator 262, vehicle battery 264 and battery sensor 266.

In general operation, when vehicle 100 is in an operating state, electrical power generator 262 converts mechanical energy from vehicle 100 to electrical energy, which is provided to electrically-powered devices of vehicle 100, including vehicle electrical loads 238. Electrical power generator 262 also provides electrical energy to vehicle battery 264 to charge vehicle battery 264, as needed.

In the event that electrical energy or power required by vehicle electrical loads 238 surpasses an electrical power output of electrical power generator 262, vehicle battery 264, an electrical storage device, will begin to provide electrical power to vehicle electrical loads 238, in addition to electrical power generator 262. If such a state continues, the stored energy of vehicle battery 264 may be diminished or exhausted, causing the electrically-powered devices and loads of vehicle 100 to cease operation. In the event that vehicle battery 264 is depleted of all stored energy, essential operating systems of vehicle 100 may cease operation, causing vehicle 100 to stop “running” and not be able to resume operations, perhaps stranding the operator. Further, a repeated depletion of vehicle battery 264 may eventually damage the battery, leading to a shorter battery life.

However, embodiments of recreational vehicle dynamic load-control system 260 prevent such situations by selectively limiting, or dynamically controlling, electrical power consumed by the various vehicle electrical loads, as will be described in further detail below. Including dynamic load-control system 260 in recreational vehicle 260 facilitates the use of many electrical devices, including user-installed accessory devices, without increasing vehicle power generation and storage system size, which minimizes costs and vehicle weight. Methods of implementing load-control system 260 also improve battery health, thereby increasing battery life.

Load controller 240 receives input various sensors and devices, including from battery sensor 266. In an embodiment, load controller 240 is configured to determine battery 264 power draw, battery state-of-charge, and/or battery state-of health to determine when and how to selectively limit the power consumed by loads 238. Load controller 240 may also receive power-state input from a power-state control device 268, such as an ignition switch, to determine a power state of vehicle 100. Power states may include a vehicle “on” power state (engine or prime mover operating), an accessory-only power state (which in an embodiment is a state where the prime mover is not operating or running, and power to some loads 238 are supplied only by battery 264), or a power-off state, where the prime mover 110 or engine is not operating, and battery power is not being supplied to all or most electrically-powered devices.

Dynamic load-control system 260 is configured to dynamically and selectively control and limit electrical power consumed by the various vehicle electrical loads 238 depending on many factors. In an embodiment, and as described further below, factors include, but are not limited to, battery 264 state-of-health, battery 264 state-of-charge, one or more of a power output of electrical power generator 262, a power or current draw on battery 264, battery 264 voltage, battery 264 temperature, battery 264 temperature, an overall power draw of electrically-powered devices, an overall power draw of electrical loads 238, a vehicle 100 power state, a vehicle 100 operational mode or state, a device or load priority, vehicle environmental conditions, and in some embodiments, user input. Other factors may include system voltage (which generally reflects battery voltage), vehicle speed, engine RPM, transmission gear position and others.

Power output of electrical power generator 262 may be measured or determined by a current or power sensor in electrical connection with electrical power generator 262 and may be measured in watts, current output, or other electrical units.

Battery 264 factors, as listed above, may include real-time or average current draw on the battery as measured by a current sensor or detector, such as battery sensor 266. Battery 264 temperature may also be a factor, and may be measured by a temperature sensor on, adjacent to, or near vehicle battery 264, to measure a battery temperature. A higher temperature may indicate an actual or potential diminished battery state-of-health, suggesting that reducing the power draw on battery 264 would be beneficial to battery 264 operation and life. Battery 264 state-of-health may be determined by a number of factors, such as battery temperature, battery conductance, battery impedance, battery cycle history, and battery age. In an embodiment, load-controller 240 is configured to receive data relating to battery 264 state-of-health, such as data relating to one or more of the factors described above, to determine a battery state-of-health and compare it to one or more predetermined battery health threshold values. A relatively good battery state-of-health may allow for less reduction of power to vehicle electrical loads 238, i.e., less “load shedding,” while a relatively poor battery health may require more reduction of power.

In an embodiment, dynamic load-control system 260 is configured to not reduce power consumed by loads 238 if current draw on vehicle battery 264 is minimal, i.e., vehicle battery 264 is supplying no current, or nearly no current, to power vehicle electrical loads 238. In such an embodiment, electrical power generator 262 is able to supply enough electrical power to satisfy all vehicle electrical loads 238.

Similarly, dynamic load-control system 260 may consider that factor of a battery 264 state-of-charge when determining whether and how much power consumed by electrical devices should be reduced. If a battery state of charge is relatively high, e.g., mostly charged, power consumption may not need to be reduced because sufficient energy or power is available from the battery to power devices. Conversely, if battery 264 state-of-charge is relatively low, a load-shedding process may be necessary because less power is available from battery 264 to power the electrical devices.

In an embodiment, dynamic load-control system 260 may also take into account a vehicle 100 power state. In one such embodiment, a full dynamic range of load-shedding or power reduction may be available when a power state is in a first or “on” state, with prime mover 110 operational and providing mechanical energy to electrical power generator 262 such that power is provided to electrical loads 238. In a second state wherein electrical power generator is not generating power, such that available power is sourced solely from vehicle battery 264, and only certain devices are consuming power, dynamic load-control system 260 may consider fewer factors, with a focus on battery factors, when determining whether to restrict power consumption of limited number of vehicle electrical loads 238. In one such embodiment, power may only be consumed by critical vehicle systems and to accessory devices, when in the “accessory” power state. In a third power state, such as an “off” state, power may only be consumed by a very limited number of necessary, critical devices, such as emergency flashers, dome lights and so on. In this third power state, dynamic load-control system 260 may consider yet a different set of factors in determining which, if any, loads to reduce.

Another factor that may be considered by dynamic load-control system 260 when determining a load-shedding scheme or map is an operational mode or state of vehicle 100. An operational mode or state of vehicle 100 may relate to how the vehicle is being used, and the resultant state of prime mover 110 or engine 110. Operational modes may include various modes or states, such as a vehicle idle mode, where an engine 110 of vehicle 100 is operating a relatively low RPM (revolutions per minute) such that power output of electrical power generator 262 is below a maximum power output, a vehicle low-speed mode, where the engine of vehicle 100 is operating above idle, but still at a relatively low RPM such that power output of electrical power generator 262 is still below a maximum power output, a vehicle high-speed mode, where the engine of vehicle 100 is operating a relatively high RPM such that power output of electrical power generator 262 is below a maximum power output, and a heavy-load vehicle mode, such as a plow mode, where vehicle 100 may be in a low gear, traveling at a reduced speed. Other operational modes may be defined and considered in a load-shed plan, in addition to the examples provided above.

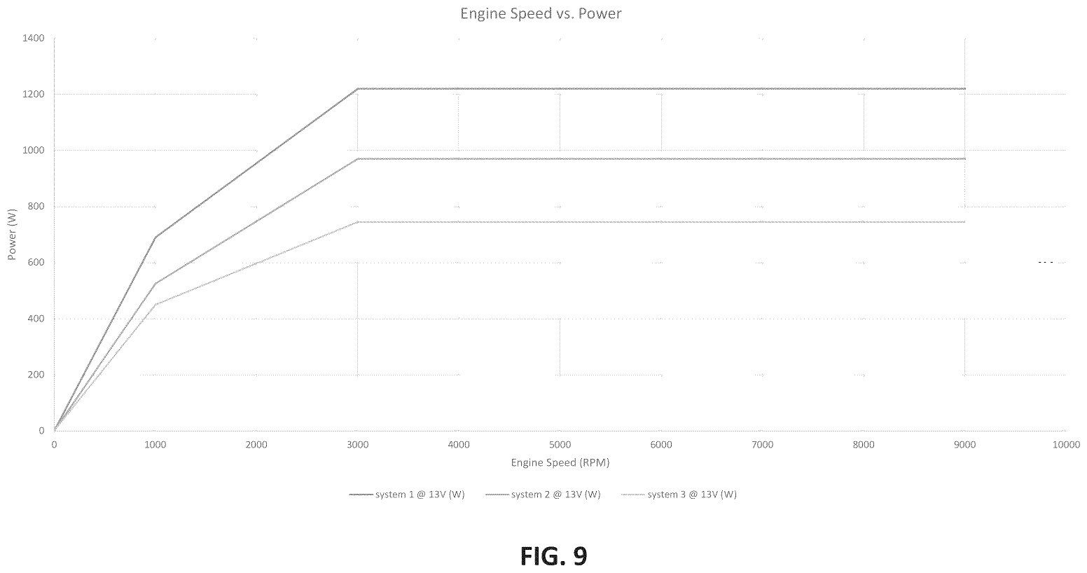

Referring to FIG. 9, a graph of power output in watts vs. engine speed in RPM is depicted for three different vehicle 100 systems (which may be three different vehicles 100). FIG. 9 illustrates that not only do different vehicle systems produce different power outputs for a given engine speed, but also that power output varies depending on engine speed. In this illustration, electrical power generator 262 of vehicle system 1 produces the most power output at any engine speed; electrical power generator 262 of vehicle system 3 produces the least power output; and electrical power generator 262 of vehicle system 2 produces power outputs between those of vehicle systems 1 and 3.

In this embodiment, for each vehicle system, electrical power output increases from 0 RPM to a threshold engine speed, which is 3,000 RPM in this embodiment, then stays constant above the threshold engine speed. In a first or idle mode, engine RPM may be in a 100 to 300 RPM range, with limited output power; in a second or low-speed range, such as 300 RPM to 1,200 RPM available electrical output is increased; in a third, high-speed range, such as 1,200 RPM and above, power output is maximized and constant. As such, the operational mode or state of vehicle 100 may be considered when determining and implementing a load-shed plan.

Referring again to FIG. 8, in an embodiment, dynamic load-control system 260 is configured to detect an engine speed, or to receive data relating to engine speed from a speed sensor, from vehicle controller 222, or from another vehicle source, and use this engine-speed data in determining an amount of power reduction for vehicle electrical loads 238. Generally, dynamic load-control system 260 is configured to increase a relative amount of power reduction or lead shedding when lower engine speeds are detected due to the less-than-maximum power generated by electrical power generator 262.

Another factor that may be considered by dynamic load-control system 260 in determining which loads 238 to reduce, is a priority of an electrically-powered device or load. For example, system 260 may not reduce power consumed by vehicle electrical loads 238 with a relatively high priority, such as vehicle head lights at night, but may reduce power to vehicle electrical loads having a low priority, such as an interior dome light during daylight hours.

In an embodiment, a predetermined priority level is assigned to each electrically-powered device, each electrically-powered device associated with an electrical load 238. The number of priority levels may affect the power-reduction granularity or incremental load shedding available to system 260. In an embodiment, system 260 defines three predetermined priority levels, such as a first priority, second priority and third priority, which may correspond to a low, medium and high-priority level. A “high” or first-level priority level may generally mean that maintaining normal operating power, or minimizing power reduction, to an electrically-powered device or load is a high priority, or relatively important. Correspondingly, a “low” or third-level priority may generally mean that reducing power to the electrically-powered device or load is generally acceptable. In other embodiments, a number of available priorities defined by system 260 may be greater or fewer than three, depending on a desired incremental level of power reduction desired. In an embodiment, a number of available priorities is in a range of two priority levels to six priority levels.

In an embodiment, every electrically-powered device of vehicle 100 participating in a load-shed plan is associated with a priority level. In other embodiments, only certain electrically powered devices of vehicle 100 are assigned a priority level. In one such embodiment, critical devices are not included in the load-control management process, such as braking or steering operations.

Load controller 240 or a memory device associated with load controller 240, may include a correspondence table or algorithm saved in memory, the correspondence table associating each electrically-powered device with a predetermined priority level. During a load-shedding or load-control process, the priority level of each device is considered to determine and implement a load-shed plan.

Another factor that may be considered by dynamic load-control system 260 in determining which loads 238 to reduce, is an amount of power consumed by an electrically-powered device or load 238. Some electrical loads 238 consume more power than other loads. For example, a seat heater may generally consume a greater amount of electrical power as compared to an LED interior light. Reducing power consumed by a small amount to a large-power-consumption device may produce larger power reductions with lower user impact.

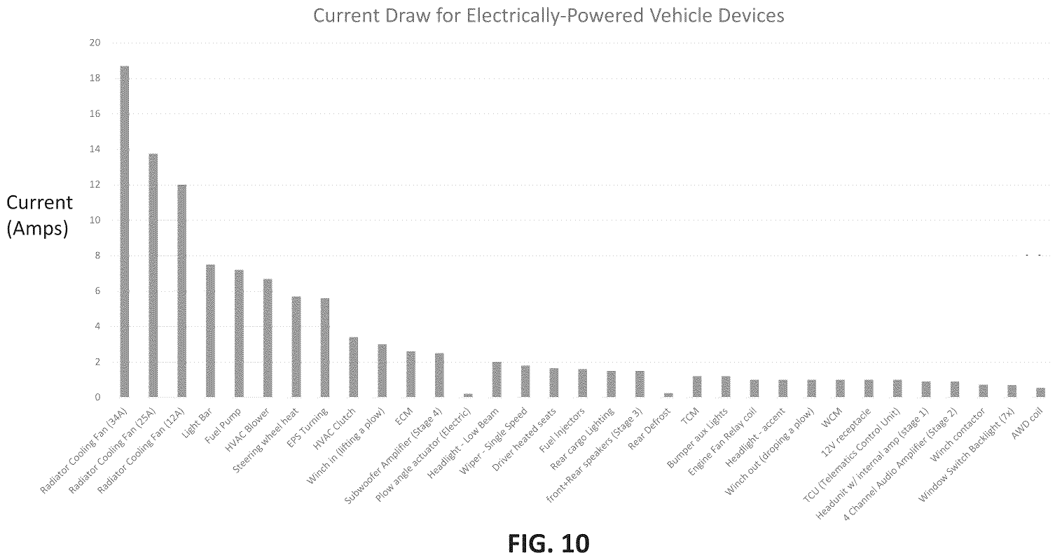

Referring to FIG. 10, a graph illustrating current draw for each of a plurality of electrically-powered devices or loads 238 of vehicle 100 is depicted. This list of devices is not intended to be an exhaustive list, but is intended to illustrate a possible range of current draws, and hence power, consumed by different types of devices of vehicle 100. At one extreme, radiator cooling fans may draw the most current, such as a 34A-rated radiator cooling fan that draws nearly 19A. At another extreme, an all-wheel drive coil draws less than 1A. An estimated amount of power consumption for each electrically-powered device may vary based on an operating mode of vehicle 100. For example, when traveling at a high speed, a radiator cooling fan may consume less power since an engine of vehicle 100 may operate at a lower temperature due to a higher volume of cooling air flowing through the radiator due to a relatively high speed. Such factors may be accounted for in a load-shed plan.

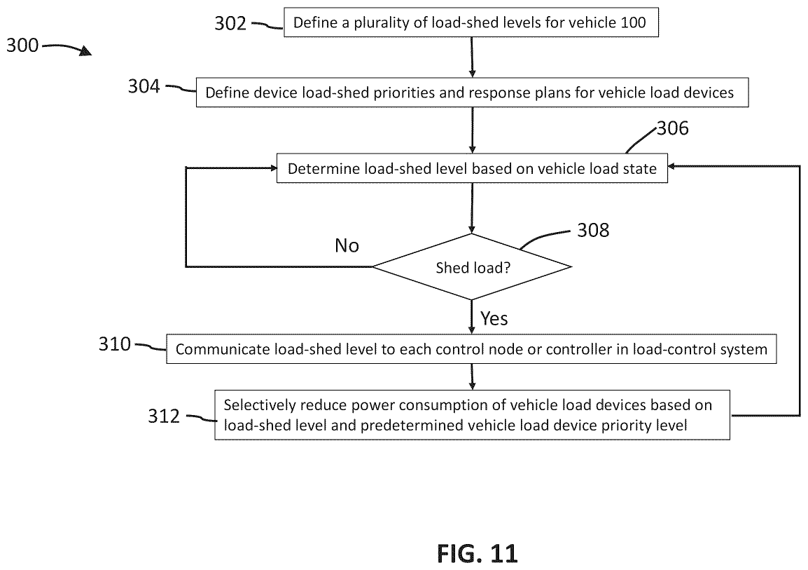

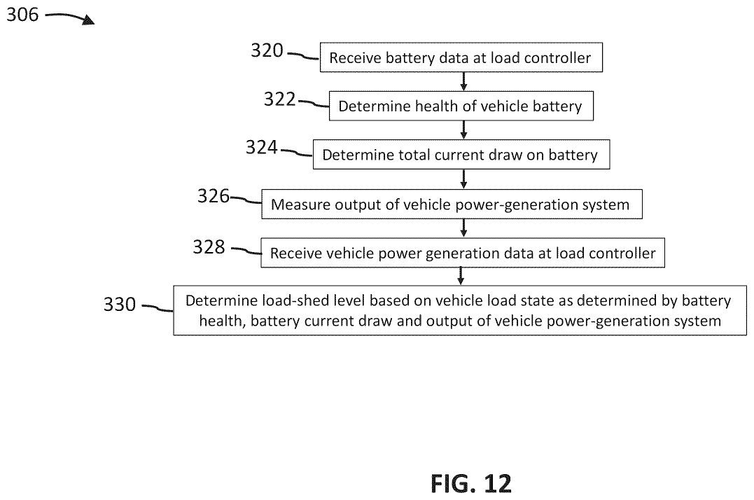

Referring also to FIG. 8, in an embodiment, an amount of measured or expected power for each device or load is determined and saved in a memory of system 260, and may be considered as part of a load-shed plan. Multiple sets of power consumption data for identified devices or loads may be saved, each set corresponding to a particular vehicle operating mode. An amount of power to be reduced or shed for a particular device is based on a device load-shed plan that takes into account overall vehicle load and determined load-shed levels, as described further below with respect to FIGS. 11 and 12.

In addition to device priority and device load-shed plans, other factors that may be considered by dynamic load-control system 260 in determining which loads 238 to reduce, and by how much, are environmental factors that may be sensed by load-related sensors 242. Such factors may be considered as part of an individual device load-shed plan. Environmental factors may include environmental conditions such as outside ambient light, vehicle-interior light, outside temperature, passenger compartment temperature, engine temperature, humidity, ambient noise, and others.

In an embodiment, a load-related sensor 242, which may be an environmental sensor, is an ambient light sensor sensing ambient light inside or outside of vehicle 100. In such an embodiment, dynamic load-control system 260 may be configured to decrease power consumed by one or more interior or accessory lights, and in some cases, even headlights, when ambient light is above a predetermined light threshold, such as may occur during daylight hours. In another embodiment, a load-related sensor 242 comprises an ambient temperature sensor that measures an ambient temperature of vehicle 100, and reduces power consumed by a radiator cooling fan, or seat heater when the ambient temperature is above a predetermined temperature threshold.

Referring to FIG. 11, as well as system diagram FIG. 8, an embodiment of a method 300 for dynamically controlling an electrical load of recreational vehicle 100 is depicted and described. In an embodiment, dynamic load-control system 260 is configured to perform the steps of method 300. Further, although the steps are presented in a particular order, it will be understood that in other embodiments, the ordering of certain steps may be changed.

Generally, an overall vehicle electrical load is continually monitored by dynamic load-control system 260, and under certain conditions, particularly when generated power drops below consumed power, i.e., devices are drawing on battery 264, system 260 with its controller 240 determines a vehicle load-shed level, communicates that load-shed level to electrically-powered devices, causing those devices to reduce power consumption based on the determined load-shed level and device load-shed plan, as described in detail below.

Step 302 comprises defining a plurality of available load-shed levels. In an embodiment, each load-shed level corresponds to a electrical load state or condition of vehicle 100 based on collective power consumed by electrical loads 238. For example, in a simple embodiment, a first load-shed level may correspond to an electrical load state of electrical loads 238 drawing less power than a capacity of electrical power generator 262. This first load-shed level is thusly a “zero” load-shed level, as power does not need to be reduced or shed since electrical power generator 262 is capable of delivering more power than loads 238 require. A second load-shed level may correspond to an electrical load state where electrical loads 238 draw slightly more power, such as more than 0% and up to 10% more power, than electrical power generator 262 can deliver, such that battery 264 is required to provide some of the power to electrical loads 238. When this vehicle electrical load state is detected or determined during operation, dynamic load-control system 260 determines that vehicle 100 is operating in a load state corresponding to a second load-shed level. Still in this example, if power consumption increases to more than 10% of electrical power generator 262 capacity, the electrical load state of vehicle 100 is “in” or corresponds to a third load-shed level.

Each load-shed level also corresponds to, or causes, a load-shed response or action to be implemented, as described further below. In the example above, determination of a third load-shed level will generally result in a greater reduction of power reduced to loads 238, as compared to a second load-shed level.

As such, step 302, defines one or more load-shed levels based on a number of factors such as electrical power generator 262 output characteristics, battery health, electrical loads 238 power consumption, durations of power consumption of electrical loads 238, battery 264 health, battery 264 temperature, battery 264 voltage, battery 264 current draw and other factors. Step 302 may include saving load-shed levels in a memory device of load-control system 260, vehicle 100 or a remote memory storage device, such as a remote memory in communication with vehicle 100 over a network. Load-shed levels may be defined by dynamic load-shed system 260, or may be defined by another computing device and saved in a memory device of dynamic load-control system 260. The step of determining and saving predetermined load-shed levels in a memory of vehicle 100 may be performed, in an embodiment, by a vehicle 100 manufacturer.

The number of defined load-shed levels may vary depending on a granularity of power-reduction control desired, with more load-shed levels corresponding to finer incremental reductions available. In an embodiment, a number of defined load-shed levels is in a range of one to ten load-shed levels, though in some embodiments, even more than ten load-shed levels are possible. In an embodiment, a number of defined load-shed levels is in a range of two to four. In an embodiment, one of the plurality of load-shed levels is a load-shed level “zero,” which indicates that no power reduction is needed. In an embodiment, system 260 includes three predefined load-shed levels.

In an embodiment, a single set of load-shed levels is defined, independent of vehicle 100 operational modes. In another embodiment, multiple sets of load-shed levels are defined, one for each vehicle operational mode. As described in part above, a number of factors affect how much power electrical power generator 262 may produce or output, including a vehicle operating mode. Consequently, in some embodiments, multiple sets of load-shed levels may be defined and stored in a memory, such as memory device of load controller 240. For the purposes of illustration, in the following description of method 300, a single or static vehicle operational mode is assumed. In an embodiment, load-shed levels may be defined by current draw on battery 264, such that defining a plurality of predetermined load-shed levels at step 302 includes determining a base-threshold current draw on battery 264 and defining each of the predetermined load-shed level as a battery-current-draw level, range or percentage of base-threshold current draw or ranges, each of the plurality of battery-current-draw levels greater than the base-threshold current draw. For example, if a base-threshold current draw is 1 amp, a first load-shed level may correspond to a battery current draw that is greater than one amp, but less than 5 amps. A second load-shed level may correspond to a battery current draw of 5 amps up to, but not including 10 amps, and a third load-shed level may correspond to a battery current draw of 10 amps or greater.

In another embodiment, defining a plurality of predetermined load-shed levels includes determining a base-threshold electrical power generator 362 output and defining each of the plurality of predetermined load-shed levels based on the base-threshold power-generation system output. For example, first, second and third load-shed levels correspond to 80 amps or less, 80 to 100 amps, and greater than 100 amps, respectively.

In another embodiment, load-shed levels are determined by engine rpm or speed. In an embodiment, a load-shed level corresponds to an engine rpm range.

In an embodiment, method 300 includes step 304 which comprises defining a device load-shed priority and load-shed response plan for each electrically-powered device or load 238. In an embodiment, and as also described above, a device load-shed priority generally indicates a priority for receiving available power, with power being reduced to “lower” priority items before “higher” priority devices, or more power reduction for lower priority devices as compared to higher priority devices. Further, device priority may determine certain actions taken by system 260 during a load-shed event. In one such embodiment, device load-shed priority levels determine whether power will be reduced with or without warning to a user, and whether a user must approve of the power reduction or load shed prior to it being implemented.

In an embodiment, dynamic load-control system 260 defines a plurality of device load-shed level priority levels. In one such embodiment, system 260 defines three load-shed priority levels, though in other embodiments, more or fewer priority levels may be defined. In a three priority-level embodiment, a first device load-shed priority level is associated with implementing a load-shed action, such as a power reduction to the first-priority-level device, without issuing a warning to a user or operator and without requiring user approval or interaction. A second device load-shed priority is associated with implementing a load-shed action when system 260 issues a warning to a user, such as displaying the warning via a display screen of user interface 226 (FIG. 7), or by issuing an audible warning. In an embodiment, system 260 implements the load-shed action for the second-priority-level device following the warning, and without user approval. A third device load-shed priority is associated with implementing a load-shed action only after issuing a warning to a user, and only after a user accepts or agrees to the pending load-shed action.

In an embodiment, system 260 communicates not only the warning, but also may display a graphical interface displaying an explanation of the load-shed action, as well as graphical buttons corresponding to accepting or rejecting the proposed load-shed action by a user.

With respect to load-shed response plans, in an embodiment, in addition to a predetermined device priority, each electrically-powered device or load 238 may be assigned or associated with a predetermined device load-shed response plan. In an embodiment, the load-shed response plan includes a set of load-shed action instructions, with one or more load-shed action instructions associated with each load-shed level. In an embodiment, possible action instructions may include: no response, i.e., no power reduction; reduce power by a defined amount, which may be a finite amount, a fraction of a maximum power consumption of the device, a fraction of an average power consumption of the device, or another measured or predetermined amount, including reducing to a fixed or not-to-exceed amount; and cease all power consumption, or a 100% power reduction. Other actions are contemplated, including time delays before reduction, ramping up or down of power, and so on.

In an embodiment, system 260 defines a plurality of load-shed levels at step 302, and at step 304 defines a load-response plan for each of the plurality of electrically-powered devices or loads 238. In an embodiment, each load-response plan may be unique to each device, but each load-shed response plan defines at least one load-shed action instruction for each defined load-shed level. In an example embodiment, an accessory light bar will include a load-shed response plan that includes: a first set of action instructions corresponding to a first load-shed level, the first set of instructions causing the accessory light bar to reduce power consumption by 25% (or other power-reducing action, such as lower a light/lux output); a second set of action instructions corresponding to a second load-shed level, the second set of instructions causing the accessory light bar to reduce power consumption by 50%; a third set of action instructions corresponding to a third load-shed level, the third set of instructions causing the accessory light bar to turn off, i.e., a 100% power reduction.

In an embodiment, each electrically-powered device may be assigned a unique load-shed response plan specific to that particular device. In other embodiments, a load-shed response plan may be associated with a load-shed priority or category, such that all devices assigned a specific priority or category share a common load-shed response plan.

In some embodiments, a user may not be able to define a device load-shed priority or a device load-shed response plan for some or all devices or loads. In one such embodiment, electrically-powered devices that are installed by a manufacturer may not be user configurable with respect to load-shedding. Such devices may include devices critical, or important, to operations of vehicle 100, such as devices associated with vehicle operating systems 230.

In other embodiments, a user may define a device load-shed priority level, and/or may define, in whole or in part, a device load-response plan. This may be particularly useful with respect to adding accessory devices not originally supplied by a manufacturer as part of an assembled vehicle 100. Reducing power to accessory devices may be particularly effective as part of a vehicle load-shed plan as reducing power to such accessories may be more acceptable to a user as compared to reducing power to originally-installed vehicle devices associated with vehicle operation.

In an embodiment, when an accessory device is electrically connected to vehicle 100, load controller 240 may detect, or be notified of the addition of the accessory device. Load controller 240 may be configured to display various graphical user interfaces to the user via user interface 226, requesting information relating to electrical information of the added device. Load controller 240 may also display options for setting device load-shed priorities, and/or device load-shed action plans based on user input.

Step 306 comprises determining a load-shed level based on a vehicle 100 electrical load state. As described also above, the electrical load state is an indication of the overall electrical load on, or power consumption of, vehicle 100.

Referring to FIG. 12 (as well as FIG. 8), an embodiment of step 306 for determining a load-shed level based on vehicle 100 load state is depicted in greater detail. In this embodiment, dynamic load-control system 260 receives battery and generator data at load controller 240, such data describing the electrical load state of loads 238 of vehicle 100, and from that data determines a corresponding load-shed level.

More specifically, at step 320, battery 264 data is received at load controller 240, or at another processor in communication with dynamic load-control system 260. In an embodiment, battery 264 data may be transmitted from battery sensor 266, or a load-related sensor 242, that is configured to measure battery 264 data. Battery data may include battery current draw, battery temperature, battery impedance, battery capacitance, historical number of battery cycles, and other battery-related data.

At step 322, a health of vehicle battery 322 is determined by load controller 260. A relatively high or good battery health may be suggestive of greater battery capacity, and better ability to sustain longer intervals for supplying power to loads 238. As such, a healthier battery may also suggest that less load needs to be shed.

At step 324, load controller 260 determines, or receives data regarding, a total current draw on battery 264. As discussed above, if battery 264 continually provides power, as measured by current draw, then eventually battery 264 will be depleted or worn out. In an embodiment, an amount of battery current draw factors into load-shed level determination. Battery current draw data may be transmitted from battery sensor 266 or another load-related sensor 242, to load controller 240. In an embodiment, total current draw on battery 264 may be collected in step 320 as part of the battery data.

At step 326, power output of electrical power generator 262 is measured by a load-related sensor 242.

At step 328, vehicle power generation data from electrical power generator 262, or from the load-related sensor 242 is received at load controller 240. Such data may be an instantaneous measurement, an average over time, or even an estimate.

At step 330, load-shed level based on battery health, battery current draw and output of vehicle power-generation system is determined. In this embodiment, the battery health, battery current draw and power output of electrical power generator 262 describe the vehicle load state. This information is used to determine a corresponding load-shed level. In other embodiments, and as described in part above, other factors may be considered when determining vehicle load state and a corresponding load-shed level.

In an embodiment, a memory device of dynamic load-control system 260 stores a set of computer-readable instructions for analyzing vehicle load state data to determine a corresponding load-shed level. In one embodiment, a lookup table of vehicle load states or load-state ranges and corresponding load-shed levels may be saved in memory. An overall vehicle load state may be determined based on vehicle load data, such as battery data, generated power output and so on, then a corresponding load-shed level is determined from the lookup table.

Referring again to FIG. 11, after determining a load-shed level at step 306, at step 308, if a load-shed level is non-zero, or in other words, if a load-shed event is necessary, then at step 310, the load-shed level is communicated to control node or controllers of the electrically-powered device or load 238. If no load-shed is needed, then dynamic load-control system 260 continues to monitor the vehicle load state and determine corresponding load-shed levels.

Communication of a load-shed level may be implemented by load controller 240 transmitting a communication over CAN bus 234 or over other networks linking load controller 240 and control nodes and controllers of electrical loads 238.

At step 312, power consumption of vehicle electrical loads 238 is selectively reduced based on load-shed level and predetermined vehicle load device priority level. As described above, each device corresponding to a load 238 includes a corresponding load-shed response plan that includes a set of load-shed actions corresponding to various load-shed levels. When a particular load-shed level is received at a control node or controller of a device or load 238, the controller determines the load-shed action, such as a power-consumption reduction, that corresponds to the received load-shed level, based on the load-shed response plan for that device. The control node or controller then implements, or causes implementation of, the load-shed action, which may include reducing power consumed by the load. Consequently, power is selectively reduced to multiple loads 238 via communication of, and according to, the determined load-shed level.

Although various embodiments of the present disclosure describe automatic loadshedding devices, methods and systems, in some embodiments, a user may be able to override the automatic implementation of loadshedding. In one such embodiment, user interface 226 may be configured to receive a user input indicating to the vehicle controller 222 that loadshedding should not be implemented, such that vehicle controller 222 prevents load controller for implementing the various loadshedding features described herein. In one such embodiment, user interface 226 may instruct or warn the user that operating in a non-loadshedding mode may result in battery damage.

In an embodiment, the loadshedding system may further be configured to include various loadshedding modes corresponding to different degrees or levels of loadshedding, such as ranging from a minimum to a maximum loadshedding level, and that may correspond to numbered levels, such as level “0”, level “1”, level “2” and so on. In one such embodiment, before automatically progressing to an increased level of loadshedding, vehicle controller 222 and user interface 226 may be configured to output a warning or message prior to entering an increased loadshedding mode. In an embodiment, the warning or message may convey information relating not only to the changed in loadshedding mode or level, but also that performance of the recreational vehicle may be changed, including that the impact of the loadshedding would progressively impact the operating characteristics of the recreational vehicle and the user experience.

The following clauses illustrate the subject matter described herein.

Clause 1. A method for dynamically controlling an electrical load of a recreational vehicle that includes a load controller, a power-generation system, a battery, and a plurality of electrically-powered devices, comprising: defining a plurality of predetermined load-shed levels, each load-shed level corresponding to a reduced electrical power level consumed by the plurality of electrically-powered devices; defining a device load-priority for each of the plurality of electrically-powered devices; receiving battery data at the load controller when the recreational vehicle is operating in a first operating mode; processing the received battery data to determine a health of the battery; determining a total power consumed by the plurality of electrically-powered devices when the recreational vehicle is operating in the first operating mode; measuring an electrical output of the power-generation system when the recreational vehicle is operating in the first operating mode; determining a first load-shed level based on the determined health of the battery, total power consumed by the plurality of electrically-powered devices and electrical output of the power-generation system, the first load-shed level corresponding to one of the plurality of predetermined load-shed levels; and selectively reducing electrical power consumed by at least one of the plurality of electrically-powered devices based on the first load-shed level and the load-priority of the at least one of the plurality of electrical devices.

Clause 2. The method of clause 1, wherein defining a plurality of predetermined load-shed levels includes determining a base-threshold current draw on the battery and/or a base-threshold power-generation system output, and defining each of the plurality of predetermined load-shed levels as battery-current-draw levels or as portions of the base-threshold power-generation system output, and defining each of the plurality of predetermined load-shed levels to be equal to the expected power-generation system plus an incremental amount of power.

Clause 3. The method of clause 1, wherein defining a device load-priority for each of the plurality of electrically-powered devices includes determining a criticality of a function of the electrically-powered device relative to an operation of the recreational vehicle, and wherein determining a criticality of a function of the electrically-powered device relative to an operation of the recreational vehicle includes defining a plurality of function categories that includes a critical-function category and a non-critical-function category and assigning each device to one of the plurality of function categories.

Clause 4. The method of clause 1, wherein processing the received battery data to determine a health of the battery includes analyzing battery data that includes battery cycle history or battery age.

Clause 5. The method of clause 1, wherein selectively reducing electrical power consumed by at least one of the plurality of electrically-powered devices based on the first load-shed level and the load-priority of the at least one of the plurality of electrical devices includes the load controller transmitting a communication signal to a system node that controls or distributes electrical power to the at least one of the plurality of electrically-powered devices, the system node being a controller, and wherein the method further comprises outputting a warning signal via a vehicle user interface, the warning signal indicating a reduction in electrical power consumed by at least one of the plurality of electrically-powered devices.

Clause 6. The method of clause 5, wherein the warning signal is output prior to the reduction in electrical power.

Clause 7. The method of clause 1, further comprising receiving a data signal at the load controller from an environmental sensor.

Clause 8. The method of clause 7, wherein receiving a data signal at the load controller from an environmental sensor includes receiving a data signal at the load controller from an ambient-light sensor, and wherein selectively reducing electrical power consumed by at least one of the plurality of electrically-powered devices includes selectively reducing electrical power consumed by a lamp of the vehicle based on the received data signal from the ambient-light sensor.

Clause 9. A method for dynamically controlling an electrical load of a recreational vehicle that includes a plurality of electrically-powered devices, comprising: measuring an electrical parameter of a battery of the recreational vehicle; determining that the electrical parameter of the battery deviates from a predetermined electrical-parameter threshold; reducing electrical power consumed by a first electrically-powered device of the plurality of electrically-powered devices from a first initial electrical power consumed to a first reduced electrical power consumed, based on the deviation of the electrical parameter of the battery; reducing electrical power consumed by a second electrically-powered device of the plurality of electrically-powered devices from a second initial electrical power consumed by a second reduced electrical power supplied, wherein a percentage reduction of electrical power consumed by the second electrically-powered device is greater than a percentage reduction of electrical power consumed by the first electrically-powered device, based on the deviation of the electrical parameter of the battery from the predetermined electrical-parameter threshold.

Clause 10. The method of clause 9, wherein measuring an electrical parameter of a battery of the recreational vehicle includes measuring a current draw on the battery of the recreational vehicle and determining that the current draw on the battery is above a predetermined battery-current-draw threshold or measuring a battery voltage and determining that the battery voltage is below a predetermined battery-voltage threshold.

Clause 11. The method of clause 9, further comprising outputting a warning signal indicating a reduction in electrical power consumed by at least one of the plurality of electrically-powered devices, wherein the warning signal is output prior to the reduction in electrical power consumed.

Clause 12. The method of clause 9, further comprising defining a plurality of predetermined load-shed levels, each load-shed level corresponding to a reduced electrical power output level consumed by the plurality of electrical devices, and defining a device load-priority for each of the plurality of electrical devices.

Clause 13. The method of clause 12, further comprising analyzing the deviation of the electrical parameter of the battery from the predetermined electrical-parameter threshold to associate one of the plurality of predetermined load-shed levels with the reduction of electrical power consumed by the first electrically-powered device.

Clause 14. The method of clause 9, further comprising measuring an output of a power-generation system of the recreational vehicle, and reducing electrical power consumed by the first electrically-powered device based further on the output of the power-generation system.

Clause 15. A system for dynamically controlling an electrical load of a recreational vehicle, comprising: a plurality of electrically-powered devices, each of the plurality of electrically-powered devices associated with a device load-shed priority level; an electrical power generation and storage system in electrical connection with the plurality of electrically-powered devices; a primary recreational-vehicle controller configured to control and communicate with a plurality of recreational vehicle systems; a vehicle load controller including a vehicle load controller processor and vehicle load controller memory, the vehicle load controller in electrical communication with the primary recreational-vehicle controller, electrical power generation and storage system and the plurality of electrically-powered devices, the vehicle load controller configured to: receive data regarding a status of the electrical power generation and storage system; process the received data regarding the status of the electrical power generation and storage system to determine a load-shed level for the recreational vehicle; and transmit command data requesting a reduction in electrical power consumed by at least one of the plurality of electrically-powered devices based on the determined load-shed level and the device load-shed priority level of the at least one of the plurality of electrically-powered devices.

Clause 16. The system of clause 15, wherein the electrical power generation and storage system includes an alternating current generator and a battery.

Clause 17. The system of clause 16, further comprising a battery sensor, the battery sensor configured to sense one or more of a battery current draw, battery voltage, battery temperature and battery impedance.

Clause 18. The system of clause 15, wherein the vehicle load controller is further configured to receive a power-state control signal from the primary vehicle controller, the power-state control signal including data indicating a power state of the recreational vehicle, including whether the recreational vehicle is in an off, accessory or on power state.

Clause 19. The system of clause 15, wherein the vehicle load controller is further configured to determine the load-shed level by comparing the data regarding the status of the electrical power generation and storage system to one or more predetermined load-shed levels saved in a memory of the recreational vehicle.

Clause 20. The system of clause 15, further comprising an environmental sensor in communication with the recreational-vehicle controller, the environmental sensor including one or more of an ambient light sensor and a temperature sensor.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A method for dynamically controlling an electrical load of a recreational vehicle that includes a load controller, a power-generation system, a battery, and a plurality of electrically-powered devices, comprising:
defining a plurality of predetermined load-shed levels, each load-shed level corresponding to a reduced electrical power level consumed by the plurality of electrically-powered devices;
defining a device load-priority for each of the plurality of electrically-powered devices;
receiving battery data at the load controller when the recreational vehicle is operating in a first operating mode;
processing the received battery data to determine a health of the battery;
determining a total power consumed by the plurality of electrically-powered devices when the recreational vehicle is operating in the first operating mode;
measuring an electrical output of the power-generation system when the recreational vehicle is operating in the first operating mode;
determining a first load-shed level based on the determined health of the battery, total power consumed by the plurality of electrically-powered devices and electrical output of the power-generation system, the first load-shed level corresponding to one of the plurality of predetermined load-shed levels; and
selectively reducing electrical power consumed by at least one of the plurality of electrically-powered devices based on the first load-shed level and the load-priority of the at least one of the plurality of electrical devices.

2. The method of claim 1, wherein defining a plurality of predetermined load-shed levels includes determining a base-threshold current draw on the battery and/or a base-threshold power-generation system output, and defining each of the plurality of predetermined load-shed levels as battery-current-draw levels or as portions of the base-threshold power-generation system output, and defining each of the plurality of predetermined load-shed levels to be equal to the expected power-generation system plus an incremental amount of power.

3. The method of claim 1, wherein defining a device load-priority for each of the plurality of electrically-powered devices includes determining a criticality of a function of the electrically-powered device relative to an operation of the recreational vehicle, and wherein determining a criticality of a function of the electrically-powered device relative to an operation of the recreational vehicle includes defining a plurality of function categories that includes a critical-function category and a non-critical-function category and assigning each device to one of the plurality of function categories.

4. The method of claim 1, wherein processing the received battery data to determine a health of the battery includes analyzing battery data that includes battery cycle history or battery age.

5. The method of claim 1, wherein selectively reducing electrical power consumed by at least one of the plurality of electrically-powered devices based on the first load-shed level and the load-priority of the at least one of the plurality of electrical devices includes the load controller transmitting a communication signal to a system node that controls or distributes electrical power to the at least one of the plurality of electrically-powered devices, the system node being a controller, and wherein the method further comprises outputting a warning signal via a vehicle user interface, the warning signal indicating a reduction in electrical power consumed by at least one of the plurality of electrically-powered devices.

6. The method of claim 5, wherein the warning signal is output prior to the reduction in electrical power.

7. The method of claim 1, further comprising receiving a data signal at the load controller from an environmental sensor.

8. The method of claim 7, wherein receiving a data signal at the load controller from an environmental sensor includes receiving a data signal at the load controller from an ambient-light sensor, and wherein selectively reducing electrical power consumed by at least one of the plurality of electrically-powered devices includes selectively reducing electrical power consumed by a lamp of the vehicle based on the received data signal from the ambient-light sensor.

9. A method for dynamically controlling an electrical load of a recreational vehicle that includes a plurality of electrically-powered devices, comprising:
measuring an electrical parameter of a battery of the recreational vehicle;
determining that the electrical parameter of the battery deviates from a predetermined electrical-parameter threshold;
reducing electrical power consumed by a first electrically-powered device of the plurality of electrically-powered devices from a first initial electrical power consumed to a first reduced electrical power consumed, based on the deviation of the electrical parameter of the battery;
reducing electrical power consumed by a second electrically-powered device of the plurality of electrically-powered devices from a second initial electrical power consumed by a second reduced electrical power supplied, wherein a percentage reduction of electrical power consumed by the second electrically-powered device is greater than a percentage reduction of electrical power consumed by the first electrically-powered device, based on the deviation of the electrical parameter of the battery from the predetermined electrical-parameter threshold.

10. The method of claim 9, wherein measuring an electrical parameter of a battery of the recreational vehicle includes measuring a current draw on the battery of the recreational vehicle and determining that the current draw on the battery is above a predetermined battery-current-draw threshold or measuring a battery voltage and determining that the battery voltage is below a predetermined battery-voltage threshold.

11. The method of claim 9, further comprising outputting a warning signal indicating a reduction in electrical power consumed by at least one of the plurality of electrically-powered devices, wherein the warning signal is output prior to the reduction in electrical power consumed.

12. The method of claim 9, further comprising defining a plurality of predetermined load-shed levels, each load-shed level corresponding to a reduced electrical power output level consumed by the plurality of electrical devices, and defining a device load-priority for each of the plurality of electrical devices.

13. The method of claim 12, further comprising analyzing the deviation of the electrical parameter of the battery from the predetermined electrical-parameter threshold to associate one of the plurality of predetermined load-shed levels with the reduction of electrical power consumed by the first electrically-powered device.

14. The method of claim 9, further comprising measuring an output of a power-generation system of the recreational vehicle, and reducing electrical power consumed by the first electrically-powered device based further on the output of the power-generation system.

15. A system for dynamically controlling an electrical load of a recreational vehicle, comprising:
a plurality of electrically-powered devices, each of the plurality of electrically-powered devices associated with a device load-shed priority level;
an electrical power generation and storage system in electrical connection with the plurality of electrically-powered devices;
a primary recreational-vehicle controller configured to control and communicate with a plurality of recreational vehicle systems;
a vehicle load controller including a vehicle load controller processor and vehicle load controller memory, the vehicle load controller in electrical communication with the primary recreational-vehicle controller, electrical power generation and storage system and the plurality of electrically-powered devices, the vehicle load controller configured to:
receive data regarding a status of the electrical power generation and storage system;
process the received data regarding the status of the electrical power generation and storage system to determine a load-shed level for the recreational vehicle; and
transmit command data requesting a reduction in electrical power consumed by at least one of the plurality of electrically-powered devices based on the determined load-shed level and the device load-shed priority level of the at least one of the plurality of electrically-powered devices.

16. The system of claim 15, wherein the electrical power generation and storage system includes an alternating current generator and a battery.

17. The system of claim 16, further comprising a battery sensor, the battery sensor configured to sense one or more of a battery current draw, battery voltage, battery temperature and battery impedance.

18. The system of claim 15, wherein the vehicle load controller is further configured to receive a power-state control signal from the primary vehicle controller, the power-state control signal including data indicating a power state of the recreational vehicle, including whether the recreational vehicle is in an off, accessory or on power state.

19. The system of claim 15, wherein the vehicle load controller is further configured to determine the load-shed level by comparing the data regarding the status of the electrical power generation and storage system to one or more predetermined load-shed levels saved in a memory of the recreational vehicle.

20. The system of claim 15, further comprising an environmental sensor in communication with the recreational-vehicle controller, the environmental sensor including one or more of an ambient light sensor and a temperature sensor.
